(19) United States
(12) Patent Application Publication
(10) Pub. No.: US 2011/0029342 A1
(43) Pub. Date: Feb. 3, 2011

(54) SYSTEM AND METHOD FOR MEASURING RETAIL AUDIENCE TRAFFIC FLOW AND DETERMINING PLACEMENT OF ELECTRONIC DISPLAYS TO ESTABLISH RETAIL AUDIENCE METRICS

(75) Inventor: Robert I. Wolinsky, Fairfield, CT (US)

Correspondence Address: SNR DENTON US LLP, P.O. BOX 061080, CHICAGO, IL, 60606-1080, US

(73) Assignee: Automated Media Services, Inc.

(21) Appl. No.: 12/848,852

(22) Filed: Aug. 2, 2010

Related U.S. Application Data
(60) Provisional application No. 61/230,338, filed on Jul. 31, 2009.
(60) Provisional application No. 61/315,751, filed on Mar. 19, 2010.

(51) Int. Cl. G06Q 10/00; G06Q 90/00; G06Q 30/00

(52) U.S. Cl. 705/7; 705/500

(57) ABSTRACT

A system and method for determining audience viewership of airtime segments substantially synchronously displayed on displays of an electronic display network in a retail environment may include determining zones through which a shopping cart being pushed by a customer traveled during a shopping trip. Times that the shopping carts spent in respective zones may be computed. A number of airtime segments that the customers had the opportunity to view while passing through the zones based on the times spent in the respective zones may also be computed. A report may be generated that includes the computed number of airtime segments that the customers had the opportunity to view while passing through the respective zones. Also, locations for the electronic displays to be positioned to enable the electronic display network to be viewed by at least a predetermined amount of customers that visit the retail environment may be determined and reported.

### RELATED APPLICATIONS

This Application for Letters Patent claims priority to co-pending U.S. Provisional Patent Application 61/230,338 filed Jul. 31, 2009, and co-pending U.S. Provisional Patent Application 61/315,751 filed Mar. 19, 2010; the entire contents of which are herein incorporated by reference in their entirety.

### BACKGROUND

Since the beginning of home television, audience delivery and viewership demographics have been the primary measure by which television networks have set advertising rates and by which advertisers have been willing to pay for airtime on television. The business of television is truly a numbers game—the more eyeballs watching, the more advertisers pay.

In the case of Nielsen measurement of in-home television program viewing, it is understood that gross viewership or tracking data is tallied via sampling and tracking methodologies in approximately 5,000 U.S. households, which is known as a sample set. The sample is therefore considered mathematically representative of total U.S. programming viewership in approximately 111 million television households. The tracking data collected establishes actual programming watched at various timeslots within a particular hour and day by the sample set. The actual tracking data is then scaled-up to represent total potential U.S. household viewership for each program being monitored. Ratings, generally quotients, are then applied that permit comparative assessments between programming viewing and audience delivery within a given market. Advertisers and advertising agencies have accepted these ratings as being the standard by which advertising rates are set.

In the case of in-home television, it is generally understood that programming is used to acquire an audience for the purpose of showing advertisements to viewers, and that programming desirability generates disparate audience aggregation tallies The programming may be in the form of situation comedies (“sit coms”), sporting events, reality television shows, movies, news, educational programming, and so on.

In the case of retail establishments, however, rather than having programming as in the case of in-home television to aggregate an audience, the actual goods being sold within the retail stores are the equivalent to programming that are used to draw shoppers or viewers to aggregate the shopping audiences. It is recognized that other factors, such as service, cleanliness, location, and so on, may also factor into attracting customers, but the primary draw for the shopping audience tends to be the goods being sold. In the case of out-of-home television located in retail establishments, gross audience tallies vary little as the programming (i.e., goods being sold) is consistent day-to-day, week-to-week.

For the purposes of establishing audience viewership or reach for out-of-home television located in retail establishments, historically, audience reach has been derived via cash register transaction data or tallies of purchases, whereby each transaction may represent a potential viewer. However, transaction data only accounts for the number of individuals that enter the store and actually purchase goods. Additional sampling may be used to establish how many individuals may have accompanied the shopper. The derived data (i.e., transaction data and additional sampling) from such tallies is methodologically flawed for media purposes, however, because such measurement does not establish any actual television viewing or audience reach and, as such cannot represent actual audience delivery (as described in co-pending U.S. patent application Ser. No. 12/368,232 filed on Feb. 9, 2009, which is herein incorporated by reference in its entirety), in the course of a shopper traveling through aisles or those viewers that may enter the store but not purchase any goods.

Another mathematically flawed historical methodology that has been historically used is to position a few electronic displays around the outside “raceway” aisles of the retail store as it was thought that a majority of shoppers traveled in these aisles or at locations where shoppers may dwell (e.g., deli-counters or fruits and vegetable areas). Such positioning of the electronic displays has been performed primarily to save costs as it is expensive to install electronic displays in retail stores. However, placing only a few electronic displays in the outside “raceway” aisles or dwell locations has never been accepted by advertisers or media agencies as providing quantifiable basis whereby media metrics (e.g., audience reach and frequency of view of advertisements, audience reach, and audience delivery) are believed (for shopper-based audiences) to be the same or analogous as those provided by in-home television. Consequently, as a result of the historically flawed audience measurement methodologies, no quantitative assessment can be made regarding the actual number of viewers, or audience size or reach, in out-of-home television systems located in the retail establishment. Such assessment has been shown to be true by the fact that no advertising agencies or advertisers have considered out-of-home television in retail stores to provide media metrics that are the same, analogous, or backwardly compatible to in-home media metrics.

### SUMMARY

To overcome the historically flawed methodologies in measuring out-of-home television media metrics in retail environments, the principles of the present invention provide for tracking customer traffic by tracking shopping carts or individual shoppers, collectively shopping carts or shoppers, that are traversing through a retail environment so that electronic displays of an electronic display network (out-of-home television network) can be positioned to capture an audience that meets certain media metrics (e.g., audience reach or viewership, frequency of view of airtime segments). By tracking the shopping carts through the retail environment and determining which zones are passed through by percentage of total customers that shop in the retail environment, a specific number of electronic displays can be determined and positioned in locations that satisfy an audience reach criteria (e.g., 95% of shoppers), thereby limiting the total number of electronic displays that are deployed in the retail environment while providing for media metrics that are the same or substantially similar and, therefore, backwardly compatible to in-home media metrics.

The audience reach and delivery metrics can be used (i) to assure out-of-home television platform or system users, which may be advertisers and media agencies, an actual tally of viewers, or audience delivery, and (ii) to assure that all or a certain percentage of customers or traffic have seen a particular advertisement at least one time in the course of a shopping trip. Such audience reach and delivery metrics data, which are now quantifiable, may be organized in a form consistent with typical Nielsen data and assessments utilized in its in-home television viewership sampling system, as known in the art. As a result, viewership ratings that are comparable to in-home television ratings (e.g., Nielsen ratings) may be generated based on quantifiable audience viewership in the retail environment.

One embodiment of a method for determining audience viewership of airtime segments substantially synchronously displayed on displays of an electronic display network in a retail environment may include determining zones through which a shopping cart being pushed by a customer traveled during a shopping trip. Times that the shopping carts spent in respective zones may be computed. A number of airtime segments that the customers had the opportunity to view while passing through the zones based on the times spent in the respective zones may also be computed. A report may be generated that includes the computed number of airtime segments that the customers had the opportunity to view while passing through the respective zones.

One embodiment of a system for determining audience viewership of airtime segments substantially synchronously displayed on displays of an electronic display network in a retail environment may include a storage unit configured to store data, an input/output (I/O) unit configured to communicate data signals over a communications network, and a processing unit in communication with the storage unit and I/O unit, and be configured to determine zones through which a shopping cart being pushed by a customer traveled during a shopping trip, compute times that the shopping carts spent in respective zones, compute a number of airtime segments that the customers had the opportunity to view while passing through the zones based on the times spent in the respective zones, and generate a report that includes the computed number of airtime segments that the customers had the opportunity to view while passing through the zone. Actual total number and percentage of audience reach that occurred in a respective zone may also be computed or otherwise determined.

Another embodiment of a method for determining audience viewership of airtime segments substantially synchronously displayed on displays of an electronic display network in a retail environment may include determining zones through which a shopping cart being pushed by a customer traveled during a shopping trip. Times that the shopping carts spent in respective zones may be computed. A total number of airtime segments the customers had the opportunity to view while in the retail environment may also be computed. A report may be generated that includes the computed number of airtime segments that the customers had the opportunity to view while in the retail environment. The report may also include total number of audience delivered for a given segment of time.

One embodiment of a system for determining locations for electronic displays to be positioned to form an electronic display network in a retail environment that provides verifiable media metrics may include a shopping cart tracking system configured to track paths of travel of shopping carts through the retail environment, where the cart tracking system generates shopping cart location data in tracking the shopping carts. A computing system may be in communication with the cart tracking system and be configured to (i) determine customer path statistics from the shopping cart location, the customer path statistics including a ratio associated with defined zones of travel to determine common zones of travel of customers through the zones within the retail environment, (ii) determine locations for the electronic displays to be positioned relative to the common zones of travel to enable the electronic display network to be viewed by at least a predetermined amount of customers that visit the retail environment, and (iii) report the determined locations for the electronic displays to be positioned. The cart tracking system may be configured to track individual shoppers who are not pushing shopping carts, as well.

One method for determining locations for electronic displays to be positioned to form an electronic display network in a retail environment that provides verifiable media metrics may include determining customer path statistics from measured shopping cart locations, where the customer path statistics may include a ratio associated with defined zones of travel to determine common zones of travel of customers through the zones within the retail environment. Locations for the electronic displays to be positioned relative to the common zones of travel to enable the electronic display network to be viewed by at least a predetermined amount of customers that visit the retail environment may be determined. The determined locations for the electronic displays to be positioned may be reported.

It should be understood that shopper tracking is not limited to shopping carts. One embodiment may include tracking equipment worn by individual shoppers in retail environments, such as shopping malls, department stores, drug stores, airports, etc. Alternatively, the tracking equipment may be configured to track electronic devices, such as an RFID tag or IR sensing device, that are designed to be integrated with the tracking system or devices (e.g., mobile communications devices) not designed to be integrated with the tracking system. From the data collected by the tracking system, determinations of (i) how many and where to position electronic displays may be made, and (ii) audience viewership may be made.

### BRIEF DESCRIPTION OF THE DRAWINGS

A more complete understanding of the method and apparatus of the principles of the present invention may be obtained by reference to the following Detailed Description when taken in conjunction with the accompanying Drawings herein:

FIG. 1 is an illustration of an illustrative network aisle shown to include gondolas that are used to display products that are available for purchase by customers or shoppers;

FIG. 2 is an illustration of an illustrative retail store floor plan;

FIG. 3 is a floor plan of an illustrative retail store that includes a shopping cart tracking system for tracking carts that travel throughout the retail store;

FIG. 4 is a floor plan of an illustrative retail store that includes a shopping cart tracking system that uses IR signals;

FIG. 5 is an illustrative shopping cart tracking system;

FIG. 6 is an illustration of an illustrative network environment shown to include a network service provider server that is in communication with shopping cart tracking systems via communications network;

FIG. 7 is a chart of illustrative shopping cart position data indicative of which particular zones the shopper of FIG. 2 traveled;

FIG. 8 is a chart of illustrative shopping cart velocity data representative of the velocities that the shopper of FIG. 2 traveled through the zones identified in FIG. 7 and listed in TABLE I;

FIGS. 9, 10, and 11 are graphs of illustrative shopper metrics;

FIG. 12 is an illustrative process for determining positioning of electronic displays in an electronic display network;

FIG. 13 is a flow diagram of an illustrative process for determining or recertifying audience metrics of an in-store television network;

FIG. 14 is a floor plan representation of the illustrative retail store of FIG. 4; and

FIG. 15 is a screen shot of an illustrative graphical user interface (GUI) that allows a user to generate a report of shopper data.

### DETAILED DESCRIPTION OF THE INVENTION

In order to provide for efficiency in terms of total number of electronic displays and positioning of the electronics displays that are used to form an out-of-home television network in a retail environment, the principles of the present invention provide for measuring customer traffic flow in a retail store by tracking shopping carts and/or baskets or individual shoppers as they traverse around the retail store. Zones may be established that allow a network service provider to determine through what zones customers most often travel. Customer flow and viewing metrics may be generated and used to determine locations that the electronic displays are to be positioned to capture a certain audience percentage or reach. While identifying zones of heaviest traffic allows for minimization of the number of electronic displays used to reach an audience (i.e., customers) above a desired percentage (e.g., 95% of all customers that enter the retail store), the placement of the electronic displays also provide for other media metrics, such as frequency of view by the audience and actual audience delivery totals, and as described in co-pending U.S. patent application Ser. No. 12/368,232. In addition, the media metrics determined through use of the principles of the present invention may result in the same or similar, and, therefore, backwardly compatible media metrics as traditional in-home television so that the out-of-home television audience media metrics (e.g., audience size and frequency of play) can be aggregated or compared with in-home television media metrics, thereby harmonizing the measurement scheme between each platform. Additionally, the measurement scheme establishes a unified measure system across varying retail systems that, when coupled with media metrics (i.e., audience size and frequency of play), provides a mathematically sound extrapolative environment for audience measurement (i.e., audience delivery) from out-of-home television in a retail environment.

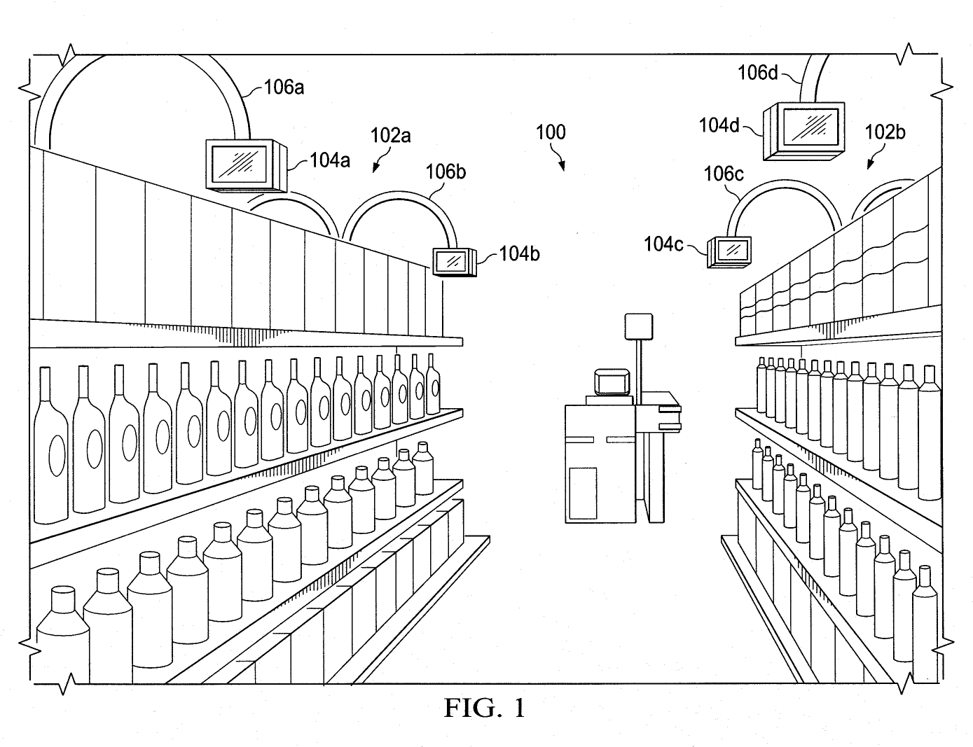

With regard to FIG. 1, an illustration of an illustrative network aisle 100 is shown to include two gondola runs 102a and 102b (collectively 102), shown on the left and right, that are used to display products that are available for purchase by customers or shoppers. The terms “customers” and “shoppers” are used interchangeably herein. The gondolas may be configured with a power bus (not shown), as described in co-pending U.S. Provisional Patent Application 61/332,503 filed on May 7, 2010, which allows for electronic displays 104a-104d (collectively 104) to be powered and be positioned in a wide range of locations along the gondolas 102. The electronic displays 104 may be paired (i.e., one electronic display faces one direction and the other electronic display faces the other direction) on each of the extension arms 106. Extension arms 106a-106d (collectively 106) may couple the electronic displays 104 to the power bus, where power and, optionally, data may be delivered to the electronic displays 104 via electrical conductors (not shown) extending through the extension arms 106.

Customers have the ability to view the electronic displays from a certain distance and adequately see an image that is being displayed on the image. The distance that a viewer can adequately can view an image on an electronic display may be based on a number of electronic display parameters, including size, contrast, sharpness, resolution, content, and so on, as understood in the art. Of course, for longer distance viewing, content displayed has to be appropriate (e.g., font size should be large). By way of example, a thirteen-inch electronic display (measured along the diagonal) with suitable image parameters may be viewed at a distance between 60 and 70 feet and allow the viewer to determine the content being displayed on the electronic display. By using distance principles in combination with audience measurements, the principles of the present invention may reduce the number of electronic displays used with a retail store and still provide for media metrics (e.g., audience reach and frequency of view). In one embodiment, a distance D between electronic displays 104a and 104b may be used between electronic displays in aisle 100 so that shoppers that are traversing along the aisle 100 have the opportunity and ability to view each airtime segment being displayed on the electronic displays 106 throughout the entire length of the aisle 100.

As a summary of the operation of the electronic displays 106 that collectively form an out-of-home television network in a retail store, the electronic displays 106 may be configured to display airtime segments substantially simultaneously with one another. Advertisements and other content displayed on the electronic displays 106 may be looped. The loop is commonly known as a “wheel.” If the average shopping trip in the retail store is a multiple of the “wheel” length, then each average shopper in the retail store has the opportunity to view each airtime segment in the “wheel” that multiple number of times. For example, if the average shopping trip in the retail store is 30 minutes and the “wheel” length is 10 minutes, then each average shopper (i.e., a shopper who shops for 30 minutes) has the ability to view each airtime segment three times. If each airtime segment is 10 seconds long, then there are six airtime segments per minute and 60 every 10 minutes. Thus, the average shopper has the opportunity to view each of the 60 airtime segments three times. In the media business, if one percent of all households in a designated market area (DMA), as defined by Nielsen, have viewed an advertisement one time, that is calculated as a one rating point in a given market. If a household, or particular demographic of viewers as assessed by the media agency, views the advertisement three times, that is considered a gross rating point. By using a wheel length that is approximately one-third the average shopping trip in the retail store, both rating points and gross rating points may be delivered by the out-of-home television or electronic display network in retail stores, which collectively makes the in-store media metrics backwardly compatible with in-home television for assessing reach to a particular audience and frequency of view as is known in the art.

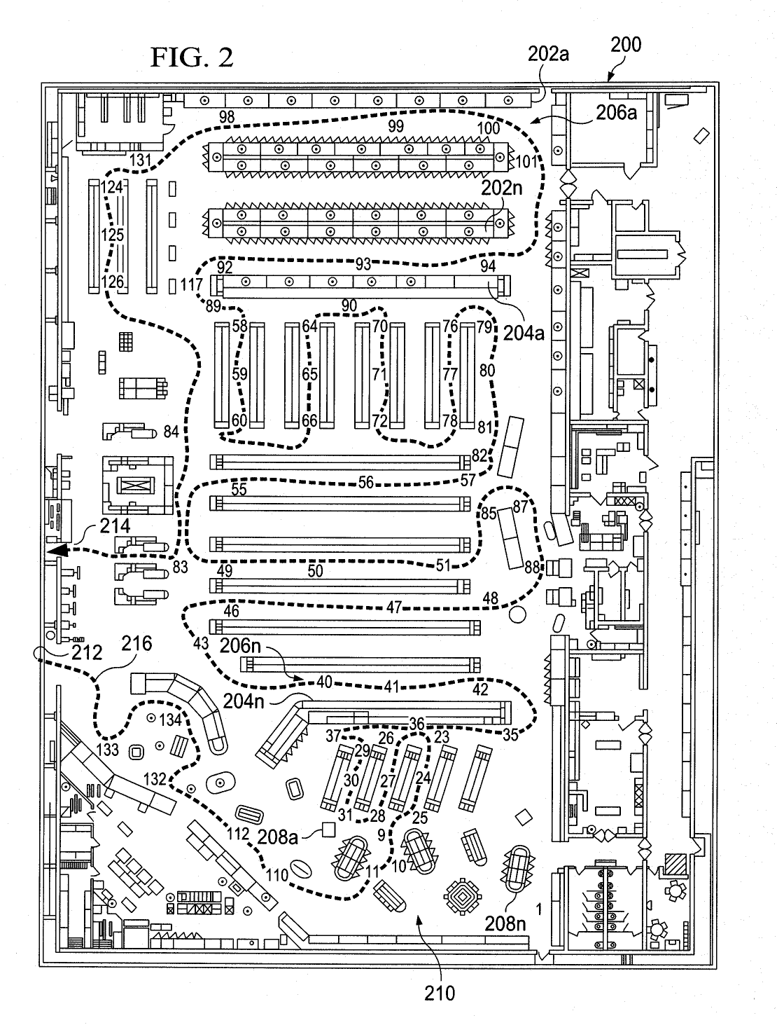

With regard to FIG. 2, an illustration of an illustrative retail store floor plan 200 is shown. The floor plan 200, which may be that of a grocery store, is shown to include refrigerators 202a-202n (collectively 202), gondola runs 204a-204n (collectively 204), aisles 206a-206n (collectively 206) extending between the gondola runs 204, product displays 208a-208n (collectively 208), and wander area 210 within which the product displays 208 reside. It should be understood that alternative configurations of the retail store floor plan 200 may be utilized in accordance with the principles of the present invention. It should also be understood that other types of retail stores may be populated with an electronic display network that forms out-of-home television, as described herein.

Shoppers enter the retail store via entryway 212 and exit the retail store via an exit way 214. An illustrative shopper pathway 216 that a shopper takes as he or she shops in the retail store is shown. The shopper pathway 216 is shown to traverse through the wander area 210 and aisles 206. To track shopper pathways that each shopper at the retail store travels, a shopping cart tracking system, which may track shopping carts and/or baskets, may be employed. The aisles 206, wander area 210, and other pathway areas may be partitioned into zones 1-134 (note that zones 1-134 are aligned with sensors 1-134 and are used interchangeably). As the shopping carts traverse through each of the zones, the shopping cart tracking system is configured to determine which of the zones the shopping carts travel. Timestamps may be used to provide for determining length of time the shopping carts are in the respective zones and speed at which the shoppers travel through the respective zones.

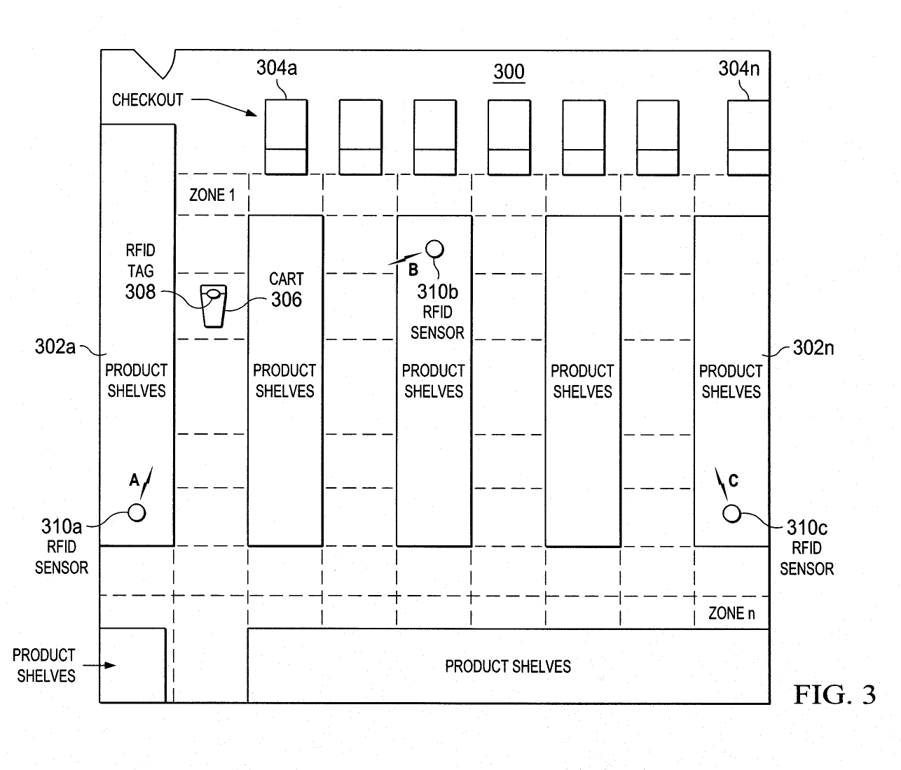

With regard to FIG. 3, a floor plan of an illustrative retail store 300 that includes a shopping cart tracking system for tracking carts that travel throughout the retail store. The floor plan 300 shows product shelves or gondola runs 302a-302n (collectively 302) that are configured to support and display products available for purchase in the retail store. Checkout counters 304a-304n (collectively 304) are available for shoppers to purchase products that the customers select from the product shelves 302.

In this embodiment, the shopping cart tracking system operates using RF signals for tracking shopping carts, such as shopping cart 306. As shown, the shopping cart 306 has an RFID tag 308 mounted thereto so that the shopping cart may be tracked as it traverses around the retail store. To track the shopping cart 306, three RFID sensors 310a-310c (collectively 310), which may be RF transponders, may be configured to communicate with the RFID tag 308 by communicating RF signals A, B, and C. RFID tag 308 may be an active RFID tag and be responsive to the RF signals A, B, and C to communicate a response signal (not shown) back to the RFID sensors 310a. The RF signals A, B, and C may be 802.11 Wi-Fi® signals. Alternatively, the RFID tag 308 may be an active RFID tag and generate a beacon signal (not shown) that each of the RFID sensors 310 receive. Still yet, the RFID tag may be a passive RFID tag and respond with an RF signal in response to being excited by the RF signals A, B, and C. Alternative RF signaling may be utilized in accordance with the principles of the present invention. A computer system (not shown) may be configured to process signals received by the RFID sensors 310 to perform a triangulation measurement to determine specific location of the shopping cart 306. As is understood in the art, RF triangulation measurements may be precise, but complex, especially with closed environments with metal shelving as is typical in retail stores. It is also understood the IR sensors may be positioned on the shelves and an IR tag/transmitter may be positioned on the cart.

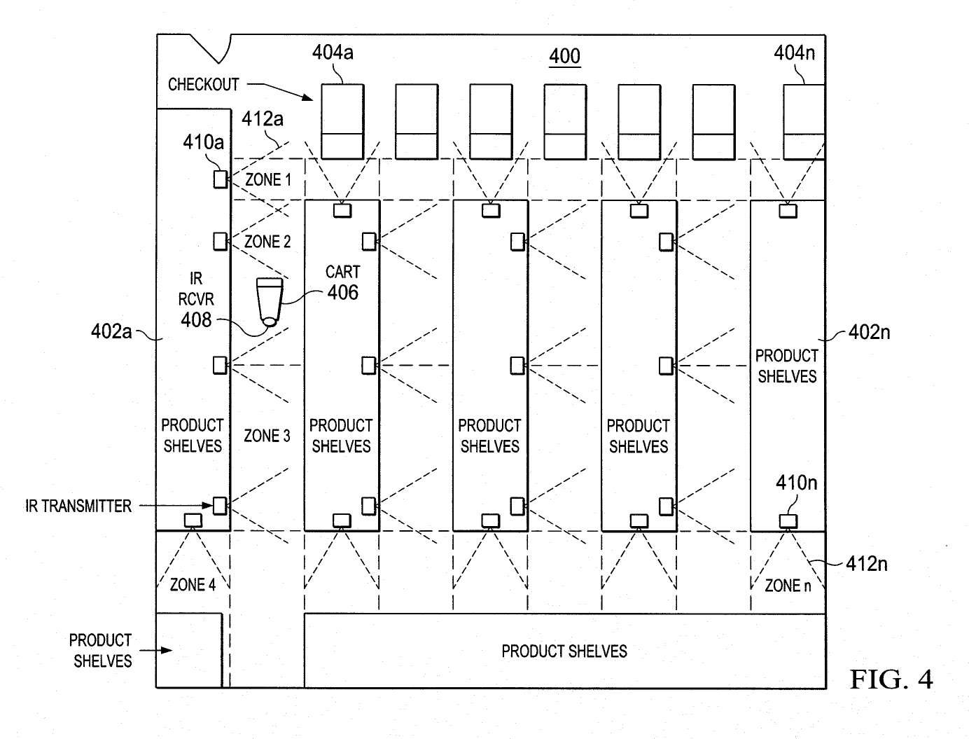

With regard to FIG. 4, a floor plan of an illustrative retail store 400 is shown. The retail store 400 has the same configuration as retail store 300 (FIG. 3), as gondola runs 402a-402n (collectively 402) and checkout counters 404a-404n (collectively 404) are positioned in the same locations as retail shelves 302 and checkout counters 304, respectively. In this embodiment, however, rather than using a shopping cart tracking system that uses RF signals, infrared (IR) signals, which are optical signals, are used. Optical wavelengths other than IR may alternatively be utilized. Further in this embodiment, cart 406 has an IR receiver 408 mounted on the front of the cart 406 so that products that are loaded into the cart 406 do not block the optical vision of the IR receiver 408. IR transmitters or tags 410a-410n (collectively 410) may be configured to generate IR signals 412a-412n (collectively 412). In this configuration, the IR receiver 408 receives the IR signals 412 communicated by respective IR tags 410. The IR signals 412 may include unique identification codes associated with respective IR tags 410 within the retail store so that the IR receiver 408 may track (i) which of the IR tags 410 are passed, (ii) in what order the IR tags 410 are passed, (iii) time that the IR tags 410 are passed, and, optionally, (iv) in what direction the IR tags 410 are passed. The IR tags 410 may be inexpensive and the resulting cart tracking system may be much less expensive than that of the cart tracking system as provided in FIG. 3. The cart tracking system of FIG. 4 is further described in co-pending U.S. Provisional Patent Application 61/315,751. It is also understood that another embodiment not shown could have an RF sensor positioned on the cart with RF tags positioned on the gondolas.

Whether a cart tracking system using RF signals and triangulation (FIG. 3) or IR signals (FIG. 4) is used, the principles of the present invention provide for establishing zones 1-n in the pathways of the retail stores 300 and 400. The zones may be related to product categories or unrelated to product categories. The zones may be regularly spaced or non-regularly spaced. In one embodiment, the zones may be defined by a grid (not shown) that is used for a planogram within the retail store that has rows and columns with regular spacings. Alternatively, the zones may be configured to be consistent with distances that electronic displays may be viewed, as described above. Customers who travel in the retail store may be tracked via the shopping carts or baskets, if so equipped, so that traffic patterns may be determined. In addition to traffic patterns being determined, shopping trip times and average shopping trip times may be determined. These shopping trip times may be determined over different days of the week and different times of the day. Still yet, because the shopping cart tracking systems provide for detailed traffic patterns and may include timestamps with each position measurement, time within each zone and speed within each zone may be computed so that the network service provider can determine (i) percentage of total shoppers that travel through which zones and directions of travel to determine where to position electronic displays so that a minimal number may be used to provide for desired media metrics, and (ii) media metrics on a zone-by-zone basis, including number of airtime segments that an average shopper (e.g., a shopper that travels an average speed in a particular zone) has an opportunity to view within each zone. Other shopper and media metrics data may be determined in accordance with the principles of the present invention.

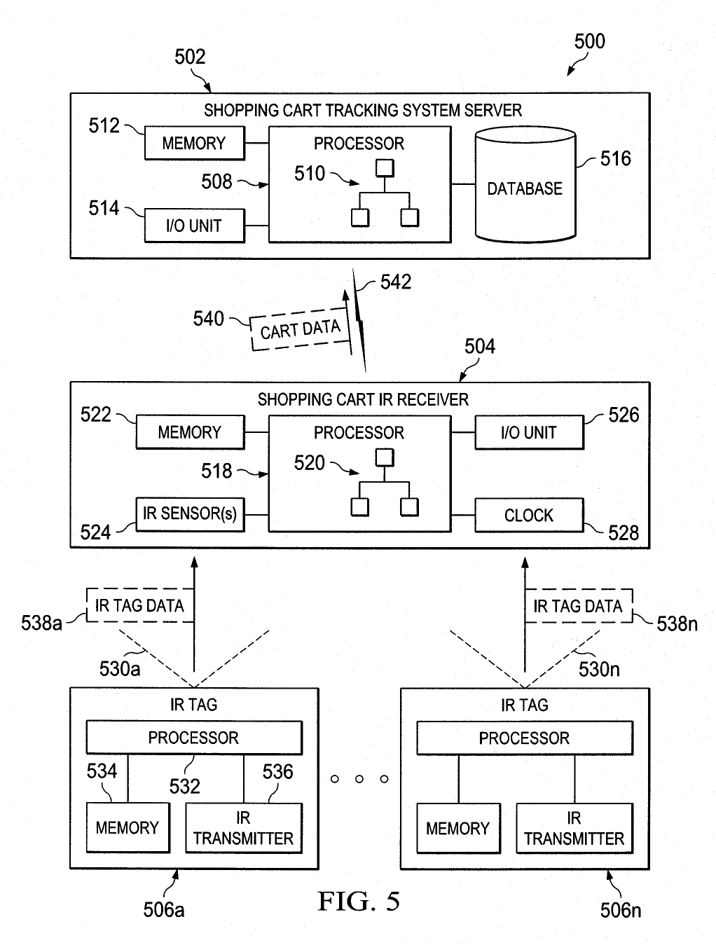

With regard to FIG. 5, an illustrative shopping cart tracking system 500 is shown. The shopping cart tracking system 500 may include a shopping cart tracking system server 502 and shopping cart IR receiver 504, if using the IR system of FIG. 4. If, alternatively, the RF system of FIG. 3 is used, then a shopping cart RFID tag would be used instead of the shopping cart IR receiver 504. It should be understood that each or a subset of the shopping carts of the retail store may be configured with a shopping cart IR receiver. If IR receivers are to be used with shopping baskets, the same or alternative electrical and/or mechanical configuration may be utilized in accordance with the principles of the present invention. IR tags 506a-506n (collectively 506) may be positioned around a retail store (e.g., below shelves) so as to define zones (e.g., start/end of zones, center of zones).

The shopping cart tracking system server 502 may include a processing unit 508 that executes software 510. The software 510 may be configured to process and manage cart tracking data. The processing unit 508 may be in communication with a memory 512, I/O unit 514, and storage unit 516 that may store one or more databases, flat files, or other data storage files. The I/O unit 514 may be configured to communicate locally with the shopping cart IR receiver 504 using a local wireless or wireline communications protocol, or remotely via a communications network, such as the Internet, mobile telephone communications network, satellite communications network, or combination thereof using the appropriate communications protocols.

The shopping cart IR receiver 504 may be configured with a processing unit 518 that executes software 520. The processing unit may be in communication with a memory 522, one or more IR sensors 524, I/O unit 526, and clock 528. The IR sensor(s) 524 may be configured to receive IR signals 530a-530n (collectively 530) communicated from the IR tags 506 positioned on shelves and other locations in the retail store. The clock 528 may be a real-time clock and be configured to generate clock data signals for the processing unit 518 to timestamp data received from the IR tags 506 via the IR sensor(s) 504. Alternatively, the clock 528 may be a clock that provides relative time without being associated with time-of-day.

The IR tags 506 may be configured with a processing unit 532 that executes software (not shown) to operate the IR tags 506. The processing unit 532 may be in communication with a memory 534 and IR transmitter 536. The IR transmitter 536 may be configured to generate one or more IR signal 530 for the IR sensor(s) 524 on the shopping cart IR receiver 504 to receive. In an alternative embodiment, rather than including a processing unit 532, IR tags that have a configuration similar to a television remote control that does not use a processing unit may be utilized to perform the same or analogous functionality as described with regard to the IR tags 506. The IR signals 530 may include IR tag data 538a-538n (collectively 538) that includes an IR tag ID that is unique within the retail store to identify which of the particular IR tags 506 in the retail store is communicating the IR signal. In addition, if the configuration of the IR transmitter 536 includes a left, right, and center IR light emitting diode (LED), the IR signal 530 may include a left, right, and/or center indicator that enables the processing unit 518 to collect direction of travel information without having to perform processing to determine direction.

In operation, as a shopper is pushing a shopping cart through a retail store, the IR tags 506 are communicating IR tag data 538 via the IR signals 530. As the shopping cart IR receiver 504 is pushed in the field-of-view of the IR signals 530, the IR sensor(s) 524 receive the IR tag data 538. The processing unit 518, in response to receiving the IR tag data 538 via the IR signals 530, may timestamp the IR tag data 538 and store the timestamped IR tag data, which is now data that is representative of cart movement (i.e., cart data or cart tracking data), in the memory 522. The processing unit 518 may be configured to store the cart data for later communication to the shopping cart tracking system server 502. In one embodiment, cart data 540, which may be the timestamped IR tag data, may be communicated to the shopping cart tracking system server 502 via a communications path 542, such as a wireless communications path (e.g., 802.11 communications protocol), (ii) hardwire communications path, or (iii) portable device (e.g., laptop computer) that, in turn, communicates the timestamped IR tag data to the shopping cart tracking system server 502 using a wireless or hardwired communications protocol. If the processing unit 518 processes the timestamped IR tag data to generate summary shopping cart tracking data or otherwise, then that cart data 540 may also be communicated to the shopping cart tracking system server 502. Alternatively, rather than using the shopping cart tracking system server 502, the portable device or non-portable device (e.g., desktop computer) may be utilized to perform the same or analogous functionality as the shopping cart tracking system server 502.

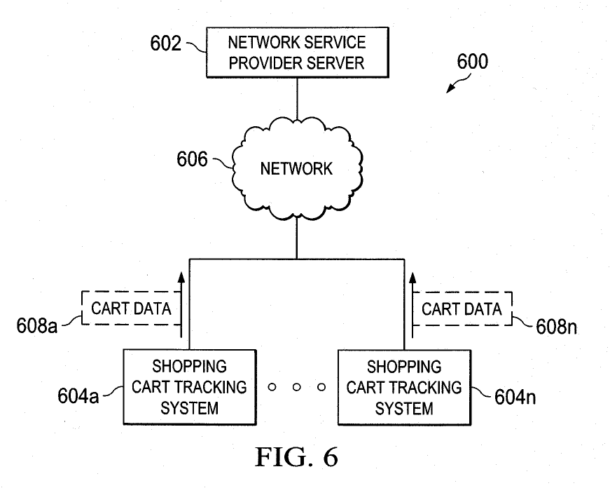

With regard to FIG. 6, an illustration of an illustrative network environment 600 is shown to include a network service provider server 602 that is in communication with shopping cart tracking systems 604a-604n (collectively 604) via communications network 606. The communications network 606 may be the Internet, mobile communications network, and/or satellite communications network. As described with regard to FIG. 5, the shopping cart tracking systems 604 may be configured to collect and/or process shopping cart tracking data from shopping carts and baskets that are moved around retail stores. In one embodiment, the shopping cart tracking systems 604 are operated at different stores of the same retailer. Alternatively, the shopping cart tracking systems 604 may be operated at different stores of different retailers. Cart data 608a-608n (collectively 608) may be communicated via the network 606 by the shopping cart tracking systems 604 to the network service provider server 602. In one embodiment, the cart data 608 may be communicated using a standard data file format, such as a comma-separated values (CSV) format. Although not shown, the network service provider 602 may be configured to include a computing system, such as a server, that includes processing unit that executes software that collects and processes the cart data 608 and stores the processed cart data 608 in a data repository. The processed cart data may be used to determine where to position electronic displays that form the out-of-home television network in the respective retail store(s) and determine media metrics of the out-of-home television networks, as described herein.

With regard to FIGS. 2, 5, and 6, a process of tracking a shopping cart and generating shopping cart metrics is provided. FIG. 2 shows a retail store 200 with the shopper pathway 216 taken by a shopper. When the shopper enters the retail store 200 with a shopping cart equipped with the shopping cart IR receiver 504, the shopping cart IR receiver 504 receives IR tag data, such as IR tag data 538a, from an IR tag, such as IR tag 506a. The IR tag data associated with each of the IR tags 506 may have an IR tag identifier with the numbered IR tags or sensors (e.g., 1-134), which are associated with zones (e.g., 1-134), as shown on FIG. 2. By timestamping the IR tag data 538 when received, the velocity (distance/time) of the shopper may be computed along the shopper pathway 216.

As the shopper pathway 216 shows, the customer passed through the following zones:

A (store entrance)-133-134-132-112-110-11-9-25-24-23-26-27-28-31-30-29-37-36-35-42-41-40-43-46-47-48-88-87-85-51-50-49-55-56-57-82-81-80-79-76-77-78-72-71-70-90-64-65-66-60-59-58-89-117-92-93-94-101-100-99-98-131-124-5-126 B4-B3 (Checkout Area).

TABLE I below provides for shopping cart metrics collected and generated by the shopping cart tracking system 500 (FIG. 5) and, optionally, the network service provider server 602. The first column of TABLE I indicates the path traversed through the retail store 200 by the shopper as provided by the shopper pathway 216 in FIG. 2. A zone is the area associated with a specific sensor. For example, two adjacent zones may be to the left and right of an IR tag. Alternatively, the IR tag may be centered within a zone. Alternative zone and IR tag configurations may be utilized in accordance with the principles of the present invention (e.g., IR tags positioned above (mounted or suspended from the ceiling) or below the zones (e.g., mounted to the floor)). The second column shows the timestamps, which indicate the time, which may be real-time or relative time, that the shopper passed each of the respective sensors. The third column indicates the calculated time, in seconds, that the shopper took to travel from the previous zone to the current zone. The calculated time may be from zone-edge to zone-edge or zone-center to zone-center depending on the configuration of the IR tags. The fourth column indicates the distance, in feet, from the previous zone to the current zone. Again, the distance may be from zone-edge to zone-edge or zone-center to zone-center depending on the configuration of the IR tags. The fifth column calculates velocity in feet per second calculated as the distance from the previous zone to the current zone divided by the time that it took to travel that distance.

TABLE I
Cart Track with Time Stamps for FIG. 2

| | | Elapsed Time | Distance from | |
|---|---|---|---|---|
| | | from Previous | previous | Velocity |
| Zone | Time | Zone (seconds) | zone (feet) | (feet/sec) |
| A (Store | 10:12:25 | 0 | 0 | — |
| Entrance) | | | | |
| 133 | 10:12:41 | 16 | 15 | 0.94 |
| 134 | 10:12:51 | 10 | 15 | 1.15 |
| 132 | 10:13:45 | 54 | 15 | 0.47 |
| 112 | 10:14:01 | 16 | 18 | 0.47 |
| 110 | 10:14:12 | 11 | 15 | 1.22 |
| 11 | 10:14:24 | 13 | 25 | 1.67 |
| 9 | 10:14:30 | 16 | 6 | 1.07 |
| 25 | 10:14:46 | 16 | 12 | 0.56 |
| 24 | 10:16:00 | 14 | 5 | 0.57 |
| 23 | 10:16:46 | 46 | 5 | 0.17 |
| 26 | 10:16:56 | 10 | 8 | 0.23 |
| 27 | 10:17:07 | 11 | 5 | 0.62 |
| 28 | 10:17:18 | 11 | 5 | 0.45 |
| 31 | 10:17:30 | 12 | 8 | 0.57 |
| 30 | 10:18:30 | 60 | 5 | 0.18 |
| 29 | 10:18:38 | 8 | 5 | 0.15 |
| 37 | 10:18:48 | 10 | 7 | 0.67 |
| 36 | 10:19:50 | 62 | 15 | 0.31 |
| 35 | 10:20:45 | 55 | 15 | 0.26 |
| 42 | 10:20:59 | 14 | 10 | 0.36 |
| 41 | 10:21:15 | 16 | 15 | 0.83 |
| 40 | 10:21:25 | 10 | 15 | 1.15 |
| 43 | 10:21:50 | 25 | 18 | 0.94 |
| 46 | 10:21:58 | 8 | 10 | 0.85 |
| 47 | 10:22:20 | 22 | 25 | 1.17 |
| 48 | 10:24:00 | 40 | 25 | 0.81 |
| 88 | 10:24:16 | 16 | 20 | 0.80 |
| 87 | 10:25:12 | 56 | 10 | 0.42 |
| 85 | 10:26:01 | 49 | 10 | 0.19 |
| 51 | 10:26:13 | 12 | 11 | 0.34 |
| 50 | 10:26:30 | 17 | 25 | 1.24 |
| 49 | 10:27:28 | 58 | 25 | 0.67 |
| 55 | 10:27:56 | 28 | 20 | 0.52 |
| 56 | 10:28:56 | 60 | 25 | 0.51 |
| 57 | 10:29:25 | 29 | 25 | 0.56 |
| 82 | 10:29:35 | 10 | 8 | 0.85 |
| 81 | 10:29:42 | 7 | 8 | 0.94 |
| 80 | 10:29:52 | 10 | 10 | 1.06 |
| 79 | 10:30:01 | 9 | 10 | 1.05 |
| 76 | 10:31:10 | 9 | 8 | 1.00 |
| 77 | 10:31:16 | 6 | 10 | 1.20 |
| 78 | 10:32:00 | 44 | 10 | 0.40 |
| 72 | 10:32:35 | 35 | 12 | 0.28 |
| 71 | 10:32:46 | 11 | 10 | 0.48 |
| 70 | 10:32:56 | 10 | 10 | 0.95 |
| 90 | 10:33:03 | 7 | 6 | 0.94 |
| 64 | 10:33:16 | 13 | 10 | 0.80 |
| 65 | 10:32:21 | 9 | 10 | 0.91 |
| 66 | 10:32:31 | 10 | 10 | 1.05 |
| 60 | 10:32:52 | 21 | 12 | 0.71 |
| 59 | 10:33:12 | 20 | 10 | 0.54 |
| 58 | 10:32:02 | 50 | 10 | 0.29 |
| 89 | 10:32:08 | 6 | 5 | 0.27 |
| 117 | 10:32:12 | 4 | 5 | 1.00 |
| 92 | 10:33:12 | 60 | 5 | 0.16 |
| 93 | 10:34:00 | 48 | 25 | 0.28 |
| 94 | 10:36:20 | 140 | 25 | 0.27 |
| 101 | 10:36:31 | 11 | 20 | 0.30 |
| 100 | 10:36:58 | 27 | 8 | 0.74 |
| 99 | 10:38:02 | 64 | 25 | 0.36 |
| 98 | 10:39:14 | 72 | 25 | 0.37 |
| 131 | 10:39:44 | 30 | 18 | 0.42 |
| 124 | 10:39:50 | 6 | 8 | 0.72 |
| 125 | 10:40:03 | 13 | 8 | 0.84 |
| 126 | 10:41:10 | 57 | 8 | 0.23 |
| B4 (Checkout) | 10:41:41 | 31 | 20 | 0.32 |
| B3 (Checkout) | 10:42:10 | 29 | 20 | 0.67 |

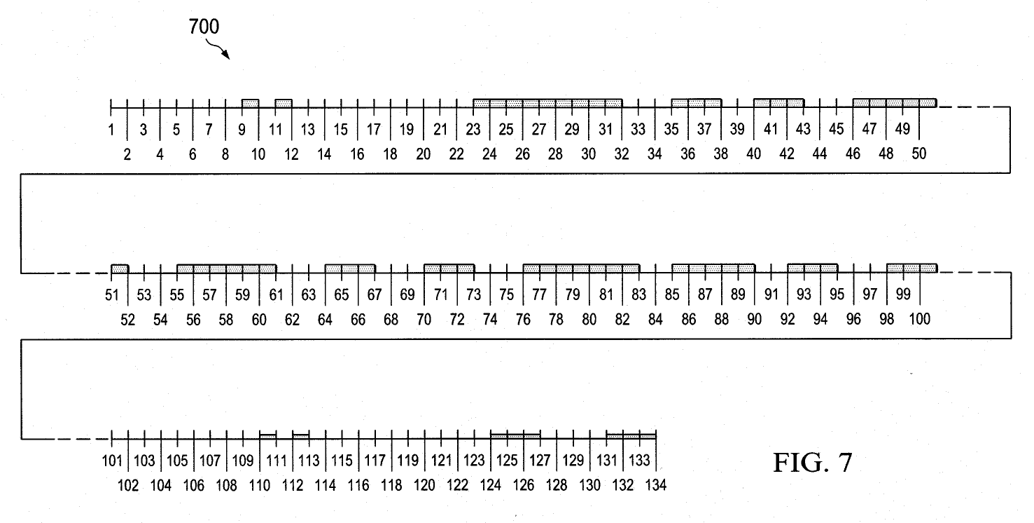

Based on the path information collected and generated by the shopping cart IR receiver 504, shopping cart tracking system server 502, and/or network service provider server 602, graphs that indicate path and velocity may be generated, as provided in FIGS. 7-11.

With regard to FIG. 7, a chart of illustrative shopping cart position data 700 indicative of which particular zones the shopper of FIG. 2 traveled. Note that the order in which the customer passed through a zone is not indicated by this chart. Only the fact that the customer passed or traveled through a zone is indicated.

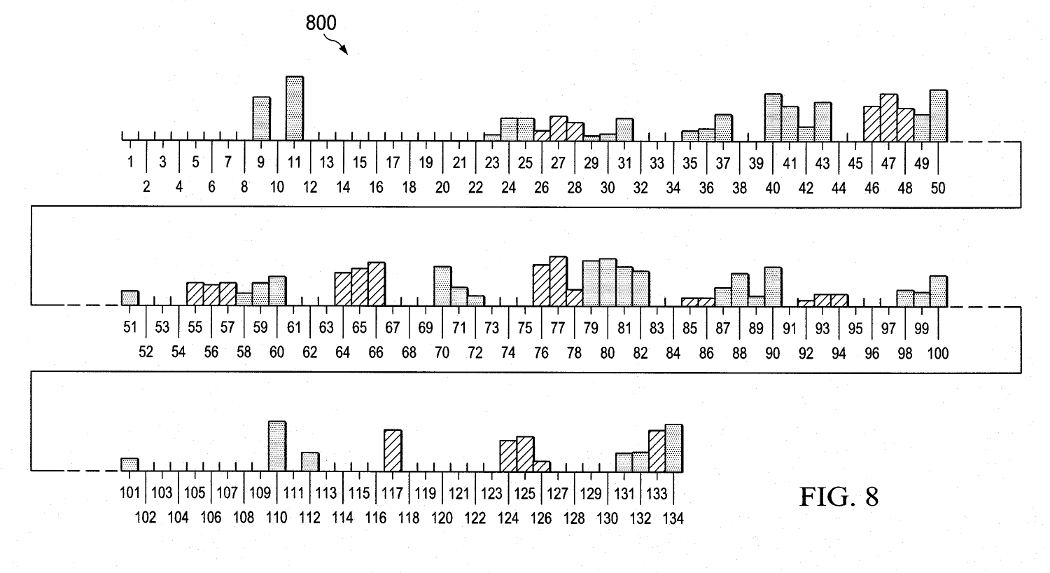

With regard to FIG. 8, a chart of illustrative shopping cart velocity data 800 representative of the velocities that the shopper of FIG. 2 traveled through the zones identified in FIG. 7 and listed in TABLE I are shown. The velocities may be calculated in feet per second or feet per minute, for example, to correspond with data units used for calculating viewing distance from electronic displays to calculate locations to position electronic displays of out-of-home television network. Note that areas through which the shopper passes in one direction are indicated by a dotted pattern, and areas through which the shopper passes in another direction are indicated by a striped pattern. The height of the bar indicates velocity.

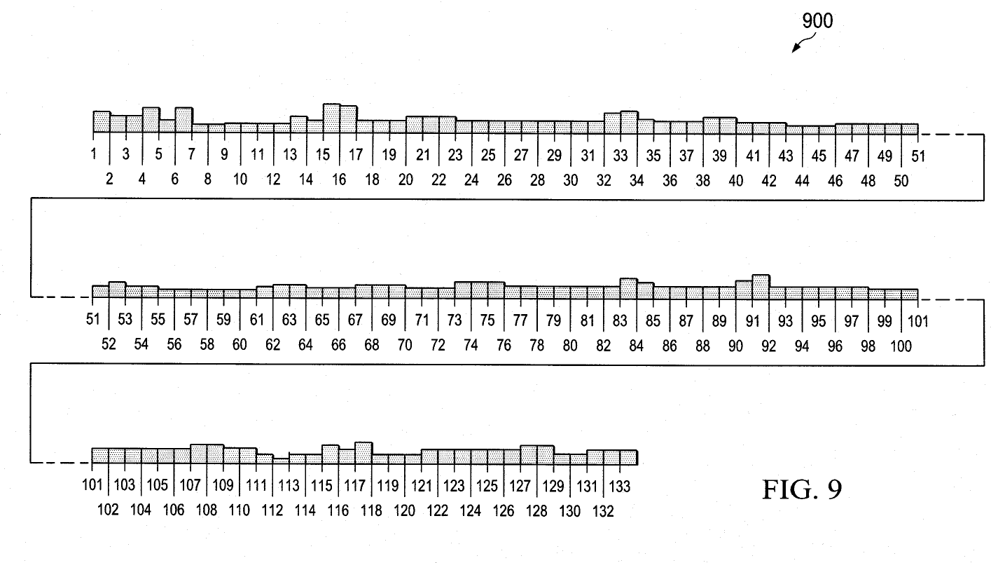

With regard to FIGS. 9, 10, and 11, graphs of illustrative shopper metrics are shown. The shopper metrics may be accumulated, averaged, or otherwise processed for cart data collected over each of the zones in the retail store 200 (FIG. 2).

FIG. 9 is a chart of illustrative shopping cart data 900 shows a total number of shoppers that enter each of the zones in the retail store 200 during a time period (e.g., between the hours of 3 pm to 6 pm, during a single day, during a week).

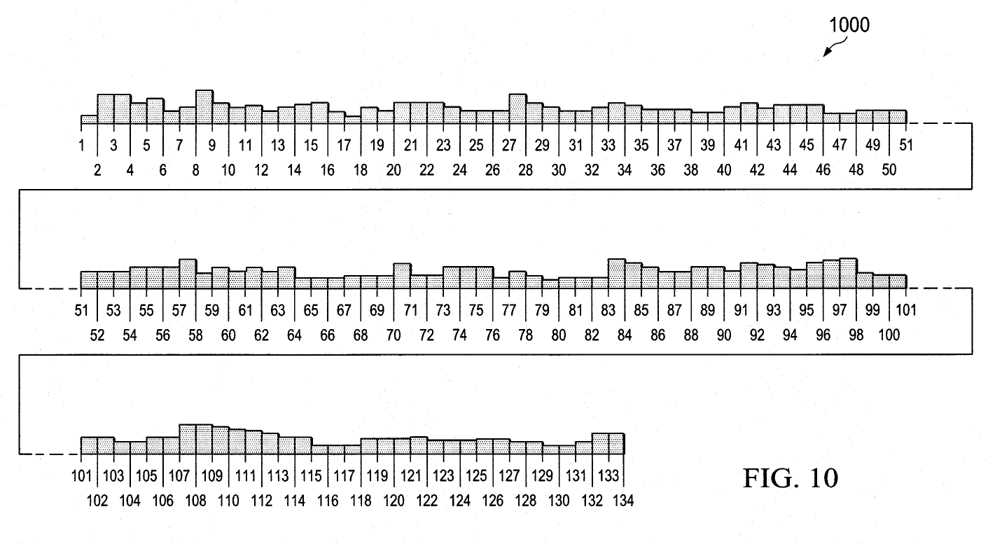

FIG. 10 is a chart of illustrative average velocity data 1000 indicative of shopper velocities through each of the zones. The total average velocity data 1000 does not indicate which direction the shoppers are traveling.

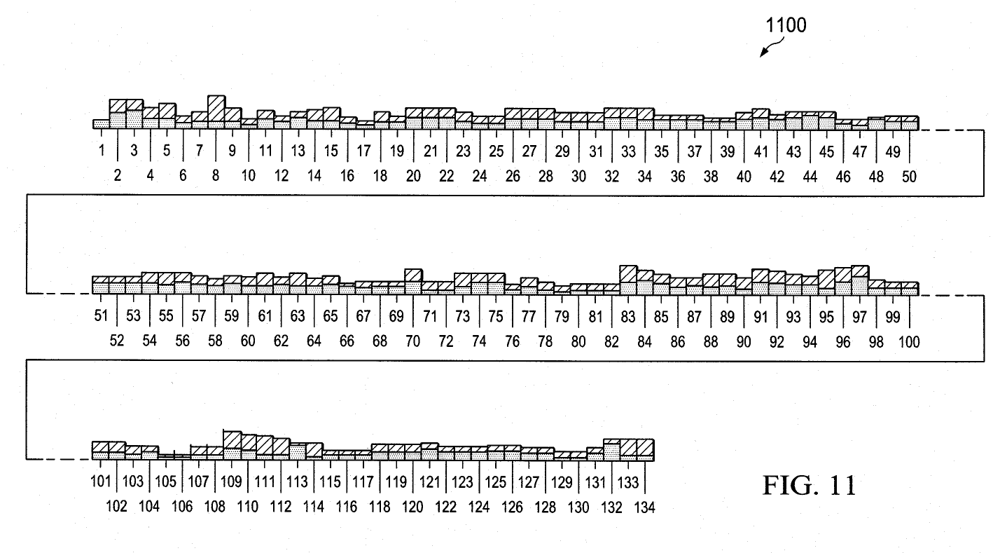

FIG. 11 is a chart of illustrative directional average velocity data 1100 that indicates both direction and velocity in the respective direction of shoppers that passed through the respective zones. As shown, the dotted portion of the bars represent shoppers traveling in one direction and the diagonally striped portion of the bars represent shoppers traveling in the opposite direction.

With further reference to FIG. 2, it can be seen that all shoppers enter the store at zone A, near zone 133, which is just to the right (below) the front entrance. Therefore, it is to be expected that more shoppers passed from zone 133 to zone 134, rather than from zone 134 to zone 133. This is indicated on FIG. 11, which shows that the dotted area at sensors 133 and 134 are much larger than the striped area. Very few shoppers pass zones 105 and 106, which are at the lower right of FIG. 2. This shopper measurement result is not unexpected since shoppers do not enter these zones unless they specifically want to purchase products that are in these zones. It can be seen that in most aisles that shopper velocity is approximately the same in both directions (i.e., the striped and the dotted area are substantially the same height).

By compiling cart tracking information from multiple shoppers, a chart showing the number of shoppers that passed through zones (See, FIG. 9) and a chart showing the average velocity of shoppers passing through zones (See, FIGS. 10 and 11) can be generated. Note that the charts in FIGS. 7-11 may be generated for specific time slices. As an example, tracking shoppers' velocity between 2:00 PM and 4:00 PM on Wednesday could be performed.

A variety of decisions may be made in configuring and operating the out-of-home television network based on the shopper metric data collected and generated by the shopping cart tracking system and, optionally, remote computing system, such as the network service provider server 602 (FIG. 6). For example, location of the electronic displays of the out-of-home television network may be established. Zones in which the electronic displays service may be set. Airtime segments may be determined to maximize average shopping trip time. Number of airtime segments in an ad “wheel” and length of the ad “wheel” may be set and determination what percentage or total number of the available shoppers in out-of-home television network are actually delivered. Additional configuration parameters and operating metrics may be set based on the shopper metrics.

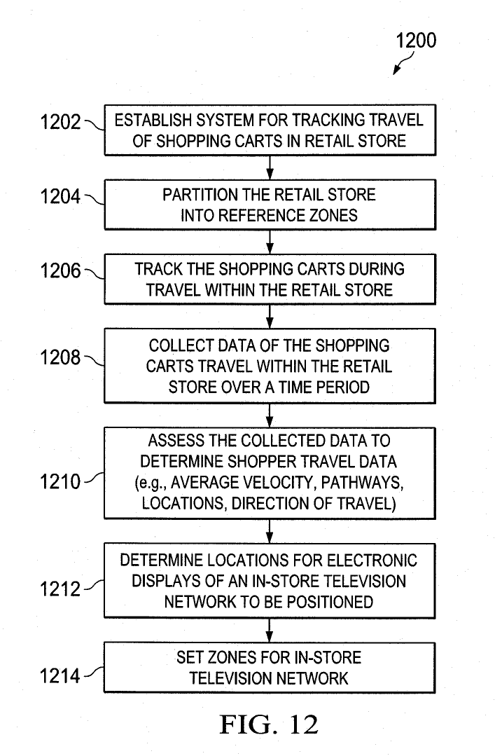

With regard to FIG. 12, an illustrative process 1200 for determining positioning of electronic displays in an electronic display network is shown. The process 1202 starts at step 1202, where a system for tracking travel of shopping carts in a retail store may be established. The system may be one of the systems described with respect to FIG. 3 or 4. In one embodiment, the system may be configured to track position and time at which position samples are taken. The shopping cart tracking system may utilize RF signals, IR signals, or any other electromagnetic or optical signals that may be used to track shopping carts and baskets that are being pushed or carried around the retail store. The shopping cart tracking system may utilize active (i.e., powered) or passive (i.e., unpowered) RFID or IR tags, as understood in the art.

At step 1204, the retail store may be partitioned into reference zones. A variety of different reference zone configurations may be utilized. If the retail store or a new retail store configuration is being measured for the first time, then shorter reference zones may be utilized to provide more resolution. If the retail store configuration has been measured in the past, then longer reference zones may be utilized since the network service provider or 3^{rd} party ratings provider may already have a basic idea of shopper traffic flow in that retail store configuration. In one embodiment, the reference zones may be formed of regularly spaced rows and columns, such as those provided in a planogram, as understood in the art. Alternatively, non-regular reference zones may be utilized. Still yet, the reference zones may be configured according to product category. Non-categorically arranged reference zones may alternatively be utilized.

At step 1206, tracking of the shopping carts may be performed. The tracking may begin at the beginning of the shopping trip and end at the cash register or when the shopper leaves the tagged shopping cart within the store without purchase. The tracking system may record each unique shopper as the shopping cart is pushed through the zones in the store. Velocity of travel may be determined, as well. In the course of a single shopping trip, it is understood that a shopper may repeat or re-circuit various areas of the store, and such movement may be tracked. It should be understood that the shopping cart tracking system may be configured to perform certain processing, such as determining total shopping time, velocity through zones, average velocity through the store, direction of travel through zones, and so on. In an alternative embodiment, another computer system may be configured to receive “raw” data collected by the shopping cart tracking system and perform the processing.

In addition to the processing for determining various shopper metrics about the shopper while shopping, another metric that retailers have heretofore been unable to quantitatively determine is the amount of time it takes shoppers to pass through a checkout station, either via a personnel operated cash register or self-checkout system. In one embodiment, each of the checkout lines may be configured as a zone so that shoppers that enter the respective zones may be tracked for the time that the shopper takes to pass through the zone. Because the shoppers are no longer potential purchasers, information about the time taken to pass through the checkout line is substantially inconsequential for media metrics purposes. However, the checkout line data may be helpful for retail store operators to improve efficiency of their retail store operations.

At step 1208, the data of the shopping carts movement through the retail store over a time period may be collected. The time period may be any time period desired by a user or be configured to automatically collect the data for a predetermined time period, such as one week. The data collected may include positions of the shopping carts and timestamps along with each of the positions within the retail store. In addition, data representative of the pathways, directional movement, velocity of travel within each zone may be collected, as well. Whether the data is collected by the shopping cart IR receiver or at a remote system by using RF triangulation techniques, the collected data may be communicated to a remote location for further processing to aggregate shopping cart tracking data from multiple shopping carts.

At step 1210, the collected data may be assessed. The assessment may include determining average shopper travel velocity, pathways that shoppers aggregate, locations, and direction of travel that shoppers travel within the zones, for example. Additional information may be assessed, as well.

At step 1212, a determination may be made as to locations for electronic displays of an in-store television network to be positioned. The determination may be made based on parameters of electronic displays and traffic patterns of shoppers that travel through common zones in the retail store. If, for example, 80% of shoppers travel through a certain pathway, then at least one electronic display may be positioned to capture that traffic. Based on an average amount of time that shoppers spend in the zone, a determination may be made as to how many airtime segments may be viewed on the electronic display(s) positioned to service that zone. There is a balance between having too many and too few electronic displays to provide opportunities for customers to view the airtime segments, where the balance is made based on the parameters of the electronic displays (e.g., size of electronic display, resolution, contrast, etc.) and traffic flow.

At step 1214, zones may be set for the in-store television network. Based on the shopper traffic flow determined in FIG. 12, a determination may be made to adjust or define new zones that each electronic display is to service. For example, if the reference zones of step 1204 are initially set as a grid used for planogram purposes, the zones may be set to match distances that shoppers are able to view the electronic displays that are positioned with respect to the shopper traffic. As an example, if an electronic display has the ability to be viewed 40 feet away, then one electronic display may be place at the ends of each aisle as opposed to using an electronic display with a 20 foot viewing distance that would necessitate one electronic display in the middle and one at the end of the aisle. In using the electronic displays with the 40 foot viewing distance, then a single zone may be positioned along the entire length of the aisle.

The process 1200 of FIG. 12 may be utilized for initially measuring and configuring a retail store with an in-store television network. If the retailer rearranges the store layout or product locations, then the process 1200 may be repeated to reconfigure the in-store television network. It should be understood that software may be used to reduce the initial 200 zones to less than 12 major zones, for example, where shoppers flow together. Other number of zones may be utilized for determining shopper tracking data. For example, it may be determined that in a particular pathway of 30 feet in length, an average shopper could view 10 twenty-second video messages. It is also logical to understand that an average shopper traveling along the same pathway could view 20 ten-second video messages in the same viewing distance. Once this database is developed, the software may locate the minimum placement points in the store for the placement of the electronic displays or television screens, based on size of screens, image viewable-distance, and aggregate viewers in each pathway, in order that a predetermined number of video messages are seen by the shopper in course of an average shopping trip. The software may also determine that such placement may yield an audience delivery percentage, up to 100% or higher because of shopper re-circuiting, as related to transaction data collected.

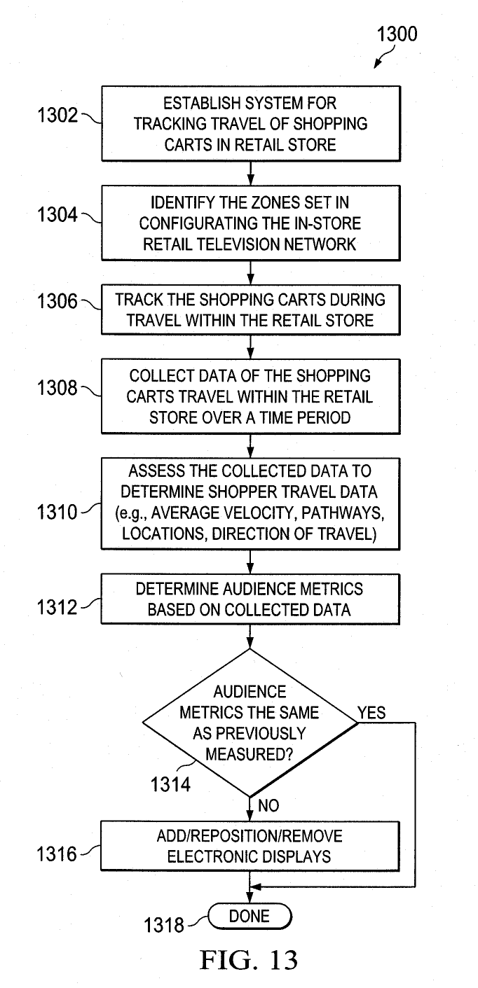

With regard to FIG. 13, a flow diagram of an illustrative process 1300 for determining or recertifying audience metrics of an in-store television network is provided. The process 1300 starts at step 1302, where a system for tracking travel of shopping carts in a retail store may be established. If the system provided in step 1202 of FIG. 12 is still in place, then that system may be utilized. At step 1304, the zones set in configuring the in-store retail television network may be identified. The zones set may be set in step 1214 of FIG. 12. As step 1306, the shopping carts may be tracked during travel within the retail store by the shopping cart tracking system. At step 1308, data of the shopping carts travel within the retail store over a time period may be collected. The collection may be performed over selected times by a user, such as daily or weekly. At step 1310, an assessment of the collected data to determine shopper travel data (e.g., average velocity, pathways, locations, direction of travel) may be performed. Audience metrics based on the collected data may be determined at step 1312. The audience metrics may include audience reach (number of viewers that had the opportunity to view each airtime segment) and frequency of view of the airtime segments while shopping. The audience metrics may be made on a zone-by-zone basis, store basis, or any other basis.

At step 1314, a determination may be made as to whether the audience metrics are the same or substantially the same (i.e., within a couple of percentage points) as previously measured. The previous measurement may be the measurement made when setting up the in-store television network. If not, the process continues at step 1316, where addition, repositioning, or removal of the electronic displays may be performed based on the shopper traffic and electronic displays, as previously described with respect to FIG. 12. Otherwise, the process ends at step 1318.

Resulting from the process 1300, a network service provider may recertify that placement of the electronic displays and the zones originally established for the electronic displays are still adequate for delivering an audience. The measurement scheme utilizing shopper velocity data may be used to certify or determine an actual number of video messages (e.g., 10-second advertisements) that a shopper can view in each zone as the shoppers travel in the store. The audience tally or reach may now be established and certified by the tracking process while re-sampling may be used to assure that the previous data assessments remain correct. If the re-sampling determines directional changes, aggregate flow changes, shopper velocity changes, and/or shopper pathway changes, the placement of the television screens may be adjusted to properly deliver media metrics (i.e., reach and frequency, delivery) that advertisers and agencies are sold. It should be understood that other factors may be used to instigate re-sampling, including changes to product placement within the retail store, changing of store layout, seasonal changes (e.g., summer versus winter), and so forth.

The process described in FIGS. 12 and 13 above may be installed in a retail store and portions may be embodied in software that is executed by a computing system, such as the network service provider server 602. It should be understood that additional or different process steps may be utilized to provide for the same or analogous functionality in accordance with the principles of the present invention. Alternative zones defined in FIGS. 3 and 4 may be utilized. As shown, the zones may have different dimensions. Although shown as being aligned across the aisles, it should be understood that the zones may have different or irregular shapes and dimensions. Resulting from the illustrative process may be the ability for the out-of-home television provider to specify specific locations for the electronic displays to be positioned within the retail store to deliver a predetermined audience reach and frequency of view of a message or advertisement. If a retail chain uses the same configuration for each of its chain stores, one or more store samplings may be used for specifying the locations of the electronic displays to provide reasonable expectation that media metrics across the entire retail chain will be satisfied (i.e., audience reach, frequency, and delivery will be approximately the same in each of the retail stores).

As described above, Nielsen in-home television measures aggregate programming viewership within predetermined time allotments. Through the use of the above-described process, the same metrics can now be determined in the out-of-home television environment. The principles of the present invention certify that the audience viewership in a retail establishment, or one or more retail chains, is factually delivered in a methodologically sound form, while accommodating differential shopper traffic flows in separate retail locations, whereby traditional media assessments and purchasing can be performed by those individuals familiar with assessing and purchasing in-home television as is known in the art. Such measurement permits traditional arithmetic and quotient-based ratings assessments as is known in the art.

While Nielsen measures common viewer blocks of time within in-home television programming whereby viewership is sampled, the principles of the present invention measures common zones of travel through product offering, or retail-style programming, within a retail location and time traveled within the zones whereby viewership is sampled. As a result, media metrics for the out-of-home television network match, or are substantially similar to Nielsen's media metrics for in-home television so that advertisers and media agencies are provided with information that is readily understandable.

The shopper metrics collected from the process of FIGS. 12 and 13 may be presented to a user in a variety of different formats. Graphs, such as those shown in FIGS. 7-11, may be used. Charts, such as TABLE I, may be utilized. Graphics, such as those shown in FIG. 4 showing zones and data on each of the zones, may be utilized. It should be understood that a wide variety of reporting may be presented to the user. Data that may be included in a report selectable by a user over a certain time period may include the following illustrative data:

(i) the specific path taken during any of the monitored shopping trips;

(ii) the velocity with which a shopper passed any of the sensors;

(iii) number of shoppers who pass a particular sensor during a specific period of time;

(iv) direction of shoppers. As an example, a determination may be made as to how many shoppers passed a specific location moving from left to right versus how many shoppers passed from right to left;

(v) average velocity of shoppers passing a particular sensor in each direction;

(vi) how many shoppers at least partially re-circuit the store

(vii) number of ads viewed in each zone based on average speed of shoppers in each zone;

(viii) number of ads viewed in the retail store based on average speed of shoppers in the retail store;

(ix) feet traveled in the retail store;

(x) incomplete trips of shoppers (i.e., shoppers who stop shopping and leave without purchasing; and

(xi) average time to pass through checkout on a per employee or line basis.

The end result of using the system and methodologies described herein provides data that may be used to generate a linear function of viewing time and distance of audience members (i.e., shoppers). By generating the linear function, positioning of electronic displays may be made in such a way that maximizes viewership and minimizes the number of electronic displays, thereby producing an in-store network that has an audience that includes substantially every shopper that enters the store in a cost effective manner. In one embodiment, a calculation may be made in the following manner: 50 ads/wheel×7 second ads/60 seconds/minute=5.8 minutes×3 views per ad=17.5 minutes of viewing time that has to be aggregated. To account for the full 17.5 minutes of viewing time, zones over which a certain percentage of shoppers travel and spend a determined amount of time using the tracking system may be determined for placement of the electronic displays. By tracking shopper traffic, a scientific methodology may result in accurate audience measurement, which allows a network service provider to accurately position the electronic displays, retailers to better design their stores, advertisers to monitor effectiveness of their advertising, and advertising media agencies to plan and buy the retail-based audience delivery with metrics that are substantially similar to traditional television metrics for planning and buying audiences.

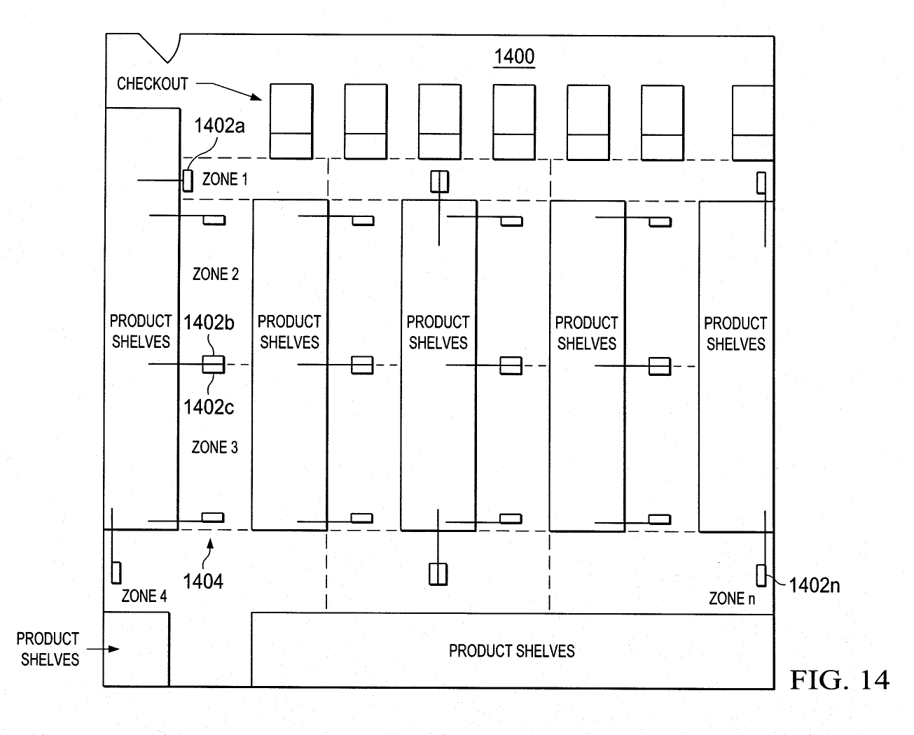

With regard to FIG. 14, a floor plan representation of the illustrative retail store 400 of FIG. 4 is shown. In this embodiment, electronic displays 1402a-1402n (collectively 1402) may be positioned throughout the retail store 400 based on measurements by a shopping cart tracking system and electronic display parameters. Zones may be established that each of the electronic displays 1402 service. Electronic displays 1402b and 1402c may be connected to the same extension arm and be placed back-to-back so that shoppers traveling different directions along aisle 1404 may have an opportunity to view respective electronic displays 1402b and 1402c. The electronic displays 1402 may be automatically positioned on the floor plan representation. Alternatively, the electronic displays 1402 may be manually positioned on the floor plan representation by a user who is provided a report with corresponding numerical values that identify locations on the floor plan to position the electronic displays and percentage of audience reach or delivery. In determining where to place the electronic displays, a criteria may be set such that an electronic displays is substantially always in sight of a shopper so that a positive determination may be made that each shopper has an opportunity to view each airtime segment (e.g., advertisement video clip) throughout the entire retail store.

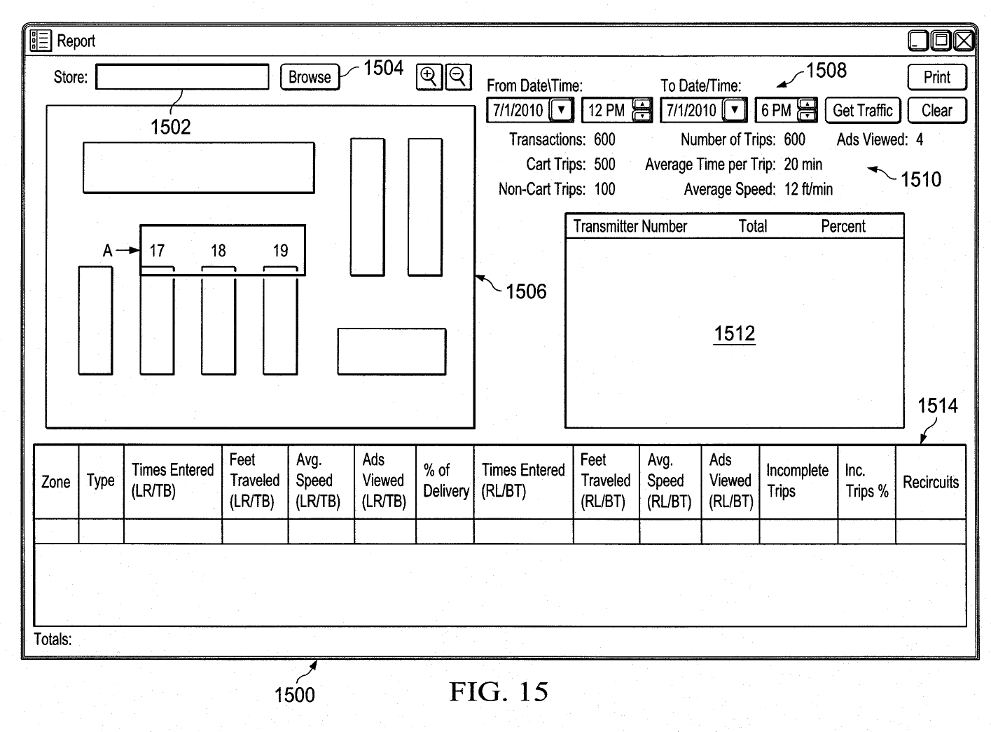

With regard to FIG. 15, an illustrative graphical user interface (GUI) 1500 is shown. The GUI 1500 may operate as a front-end system for a database, such as an Oracle database that stores data collected from IR receivers, such as shopping cart IR receiver 504 (FIG. 5). As shown in the GUI 1500, a user may enter a store identifier in an entry field 1502, where the store identifier is associated with a graphical representation of a floor plan. In one embodiment, a “browse” soft-button 1504 may be provided to enable the user to browse through a directory to locate an image file associated with the retail store. In response to the user selecting the image file, a graphical representation of a store layout 1506 may be presented to the user.

The GUI 1500 may be interactive in that a user may have the ability to draw zones, such as zone A displayed on the store layout 1506. As shown, zone A includes at least a portion of IR tags 17, 18, and 19. As described below, shopper data that is collected by the IR receivers that includes IR tags 17, 18, and 19 being detected may be associated with zone A.

As further shown in FIG. 15, report input data fields 1508 may be used to enable the user to select what report parameters to use to view shopper data. The input data fields 1508 may include “From Date/Time” and “To Date/Time” selectable data entries. Shopper data 1510 may be displayed so that the user can view how many transactions, number of cart trips, number of non-cart trips, number of total trips, average time per trip, average speed, and number of ads viewed (frequency) by each shopper based on the shopper data 1510. Although shown as being equal, the number of transactions and number of trips may be unequal if for example, shoppers made more or fewer transactions than pushed carts or carried baskets. In addition, a table 1512 listing data specifically associated with each transmitter may be presented to the user. The table 1512 may include “Transmitter Number,” “Total,” and “Percent.” The “total” may indicate the total number of shoppers that entered and/or exited a zone in which a transmitter is associated. The “percent” may represent the percentage of all shoppers that entered a zone associated with a transmitter. Rather than using “transmitter number” as a data field, “zone number” or “grid coordinates” may alternatively be used.

In addition, another table 1514 may be presented to the user to display detailed shopper data. The shopper data may include: “Zone,” “Type,” “Times Entered,” “Feet Traveled,” “Avg. Speed,” “Ads Viewed,” “% of Delivery,” “Times Entered,” “Feet Traveled,” “Avg. Speed,” “Ads Viewed,” “Incomplete Trips,” “Incomplete Trips %,” “Recircuits.” The table may show whether the shopper entered from the left, right, top, or bottom of the zone to provide additional traffic pattern information. Incomplete trips are indicative of shoppers start shopping, but leave without completing a transaction (e.g., leaving the cart in the store without passing through checkout). As shown, the shopper data is shown on a per zone basis. It should be understood, however, that alternative bases may be used to present the data in accordance with the principles of the present invention. Ultimately, the shopper data displayed may be used to assist the user in defining zones that may be used to identify where a certain percentage of shoppers (e.g., 100%) (reach) travel so that each shopper has the ability to view each airtime segment a certain number of times (frequency of view).

The process provided in associated with FIG. 15 is a manual process. However, it should be understood that an automated process may be created to determine where specific zones are to be positioned to minimize total number of zones and electronic displays. In automating the process, the zones may be started at the entrance and expand therefrom depending on the store configuration. For example, a zone may be established at the entryway, a next zone may be positioned along an aisle that extends from the entryway, a zone may be positioned in an aisle that extends from the aisle in-line with the entryway, and so forth. Electronic displays with different operating parameters may be used to have long or short zones that align with traffic flow in the retail environment.

While description describes the principles of the present invention as being primarily utilized within retail stores, it should be understood that the principles of the present invention may be used with retail environments. Retail environments may include shopping malls, airports, stadiums, arenas, museums, department stores, drug stores, and any other place where people aggregate.

It should further be understood that in addition to the retail environments, that people in non-retail environments may be tracked. As an example, tracking specific vehicles throughout a roadway multiple roadways may be tracked and zones may be established to determine placement of signs, electronic and/or non-electronic, and audience delivery for content displayed on the signs. By tracking specific vehicles rather than total vehicle count without identifying particular vehicles, media metrics may be better determined. For example, by knowing specific vehicles that travel a certain stretch of highway, a determination may be made as to how many of the same people had the opportunity to view a single advertisement a certain number of times. In tracking the specific vehicles, toll-tags of the vehicles, other electronic devices that may be installed in the vehicles, license plates, or other identifying means may be monitored and tracked. If, for example, license plates are used, imaging software may be utilized to perform identification of the license plate number. Software executed on a computing system may track zones in which the vehicles travel on the roadway.

In addition, the principles of the present invention allow customer or shopper data to be collected using non-shopping cart and non-basket techniques. Such techniques may provide for tags or sensors to be carried or worn by a user (e.g., hand-held device or badge attached to clothing) to track the person with the tags or sensors as the customers travel throughout the retail environment.

The previous detailed description of a small number of embodiments for implementing the invention is not intended to be limiting in scope. One of skill in this art will immediately envisage the methods and variations used to implement this invention in other areas than those described in detail.

We claim:

1. A system for determining locations for electronic displays to be positioned to form an electronic display network in a retail environment that provides verifiable media metrics, said system comprising:
a shopping cart tracking system configured to track paths of travel of shopping carts through the retail environment, said cart tracking system generating shopping cart location data in tracking the shopping carts; and
a computing system in communication with said cart tracking system and configured to:
determine customer path statistics from the shopping cart location, the customer path statistics including a ratio associated with defined zones of travel to determine common zones of travel of customers through the zones within the retail environment;
determine locations for the electronic displays to be positioned relative to the common zones of travel to enable the electronic display network to be viewed by at least a predetermined amount of customers that visit the retail environment; and
report the determined locations for the electronic displays to be positioned.

2. The system according to claim 1, wherein said shopping cart tracking system is further configured to generate timestamp data associated with location data, and wherein said computing system is further configured to:
determine time spent within the common zones of travel; and
wherein said computing system, in determining locations for the electronic displays to be positioned relative to the common zones of travel, utilizes the determined time spent in the common zones of travel.

3. The system according to claim 1, wherein said shopping cart tracking system is further configured to determine direction of travel by the customers within the common zones of travel, and where said computing system is further configured to determine locations for the electronic displays to be positioned relative to the common zones of travel based on direction of travel of the customers within the common zones of travel.

4. The system according to claim 1, wherein said computing system is further configured to enable a user to select different specification parameters that define the electronic displays, the selected different specification parameters being used to determine locations for the electronic displays to be positioned relative to the common zones of travel.

5. The system according to claim 4, wherein the different specification parameters include size and resolution and viewable distance of the electronic displays.

6. The system according to claim 1, wherein said computing system is separate from said shopping cart tracking system.

7. The system according to claim 1, wherein said computing system is further configured to:
determine whether audience metrics are substantially the same as previously measured;
if not, then determine where to add, reposition, or remove electronic displays configured to form the electronic display network;
otherwise, maintain location of the electronic displays.

8. A method for determining locations for electronic displays to be positioned to form an electronic display network in a retail environment that provides verifiable media metrics, said method comprising:
determining customer path statistics from measured shopping cart locations, the customer path statistics including a ratio associated with defined zones of travel to determine common zones of travel of customers through the zones within the retail environment;
determining locations for the electronic displays to be positioned relative to the common zones of travel to enable the electronic display network to be viewed by at least a predetermined amount of customers that visit the retail environment; and
report the determined locations for the electronic displays to be positioned.

9. The method according to claim 8, further comprising:
generating timestamp data associated with location data;
determining time spent within the common zones of travel; and
utilizing the determined time spent in the common zones of travel in determining locations for the electronic displays to be positioned relative to the common zones of travel.

10. The method according to claim 8, further comprising:
determining direction of travel by the customers within the common zones of travel; and
determining locations for the electronic displays to be positioned relative to the common zones of travel based on direction of travel of the customers within the common zones of travel.

11. The method according to claim 8, further comprising enabling a user to select different specification parameters that define the electronic displays, the selected different specification parameters being used to determine locations for the electronic displays to be positioned relative to the common zones of travel.

12. The method according to claim 11, wherein enabling the user to selected the different specification parameters include enabling the user to select size and resolution and viewable distance of the electronic displays.

13. The method according to claim 8, further comprising:
determining whether audience metrics are substantially the same as previously measured;
if not, then adding, repositioning, or removing electronic displays configured to form the electronic display network;
otherwise, maintain location of the electronic displays.
